(19) United States
(12) Patent Application Publication
(10) Pub. No.: US 2008/0148252 A1
(43) Pub. Date: Jun. 19, 2008

(54) Electronic Device, System and Method For Updating Software Online

(75) Inventor: NaiLi Deng, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/955,727

(22) Filed: Dec. 13, 2007

(30) Foreign Application Priority Data
Dec. 13, 2006 (CN) 200610161724.X

(51) Int. Cl. G06F 9/44

(52) U.S. Cl. 717/173

(57) ABSTRACT

Techniques related to updating software (e.g., firmware, code or applications) in an electronic device or system are disclosed. According to one aspect of the present invention, an updating communication program is retained a micro control unit (MCU). When needed, the updating communication program is executed by the MCU to download an updating executable program from an external device (e.g., a computer device or portable device). The updating executable program is configured to download a program for updating and write the program into a storage module as a new version to replace an old version of the program.

### BACKGROUND OF THE INVENTION

1. Field of the Invention

The present invention generally relates to software updating in a device, and more particularly, related to electronic device, system and method for updating software from another device or equipment.

2. Description of Related Art

With rapid development of information technology, all kinds of electronic consumer devices such as MP3, MP4, PMP, and PDA etc. are developed. These electronic consumer devices generally include a system on chip (referred to as SOC system hereinafter). Referring to FIG. 1, there shows an exemplary configuration of a conventional SOC system 100 that mainly includes a micro control unit (MCU) 102 and a storage module 104. The storage module 104 is a nonvolatile memory such as NOR flash memory, or NAND flash memory etc. The MCU 102 is configured for storing some necessary codes such as boot code, or encoding/decoding algorithm code etc. The storage module 104 is configured for storing a user program and a mass of data such as MP3 data.

To further improve functions of these types of devices after being sold, programs (codes) in the storage module 104 may require to be updated constantly. The general updating method includes: loading the program from the storage module 104 into a random access memory (RAM) via the boot code; executing an updating program embedded in the user program to erase an old version of user program in the storage module first and write a new version of user program into the storage module subsequently.

However, if an unpredictable error such as sudden power disruption when the old version of the program has already been erased from the storage module but the new version of user program has not been written into the storage module yet, the electronic device could be dead (not usable any more) probably because an important program is no longer available for the MCU. Thus, the electronic device has to be brought back to manufacturer for reprogramming.

It is concluded that the conventional updating method has lower reliability and presents a likelihood that an important program is erased accidentally, causing a considerable problem to the user. Thus, improved techniques for updating such devices are desired.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

Generally speaking, the present invention is related to techniques of updating software (e.g., firmware, code or applications) in an electronic device or system. According to one aspect of the present invention, an updating communication program is retained a micro control unit (MCU). When needed, the updating communication program is executed by the MCU to download an updating executable program from an external device (e.g., a computer device or portable device). The updating executable program is configured to download a program for updating and write the program into a storage module as a new version to replace an old version of the program.

One of the features, benefits and advantages in the present invention is to provide techniques for updating programs in a device from another device having an update program. The operation may be performed by an ordinary user to avoid sending his/her device to the manufacturer to update a program.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 shows an exemplary configuration of a conventional SOC system;

FIG. 2 shows an exemplary configuration of an updating system according to one embodiment of the present invention;

FIG. 3 shows an exemplary configuration of a MCU of the updating system according to one embodiment of the present invention; and

FIG. 4 is a schematic flowchart illustrating an exemplary updating method according to one embodiment of the present invention.

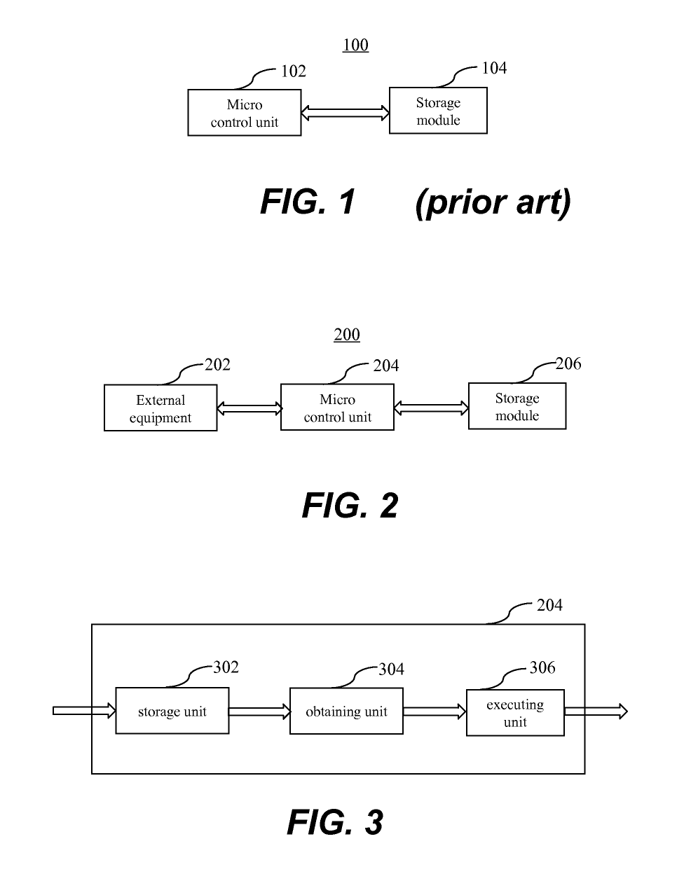

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

Embodiments of the present invention are discussed herein with reference to FIGS. 2-4. However, those skilled in the art will readily appreciate that the detailed description given herein with respect to these figures is for explanatory purposes only as the invention extends beyond these limited embodiments.

In general, an updating method according to one embodiment of the present invention comprises: firming an updating communication program into a micro control unit (MCU); executing the updating communication program by the MCU to download an updating executable program from an external device; executing the updating executable program by the MCU to download an updated program and write the updated program into a storage module to replace an old version thereof.

The updating communication program can't be easily destroyed because it is firmed into the MCU and has a read only attribute. Thus, even if the updating method is interrupted due to sudden power disruption, the updating communication program is still stored in the MCU and still capable of being executed normally. Once the power is restored, the updating method according to one embodiment of the present invention can be used to update an old version of the program in the storage module once again. Thereby, the reliability of the updating method in the present invention is ensured.

FIG. 2 shows an exemplary configuration of the updating system 200 according to one embodiment of the present invention. The updating system 200 mainly comprises an external device or equipment 202, a micro control unit (MCU) 204 and a storage unit 206. The external equipment 202 is configured for storing an updating executable program and at least a user program. The MCU 204 contains an updating communication program firmed therein. The MCU 204 executes the updating communication program to download the updating executable program from the external equipment 202, executes the updating executable program to download the user program from the external equipment, erase an old version of the user program already in the storage module 206, and write the user program into the storage module 206 as a new version to replace an old version in the storage module 206. The storage module 206 is configured for storing the user program which may be updated constantly.

FIG. 3 shows an exemplary configuration of the MCU 204 of the updating system 200 according to one embodiment of the present invention. The MCU 204 comprises a storage unit 302 such as a ROM for retaining the updating communication program received, a fetching unit 304 for downloading the updating executable program compatible with the type of the storage module 206 from the external equipment 202 by executing the updating communication program, and an executing unit 306 for executing the updating executable program to download a user program from the external equipment, erase the old user program in the storage module 206, and write the user program into the storage module 206.

The external equipment may be a computer device, or other terminal devices having a communication interface, an example of such a device includes MP3, MP4 player or PMP etc. The storage module 206 is a nonvolatile memory such as NOR flash memory, or NAND flash memory etc.

For further understanding the present invention, a specific example is described below provided that a computer device serves as the external equipment, the flash memory serves as the storage module, and the updating communication program is firmed into a ROM of the MCU.

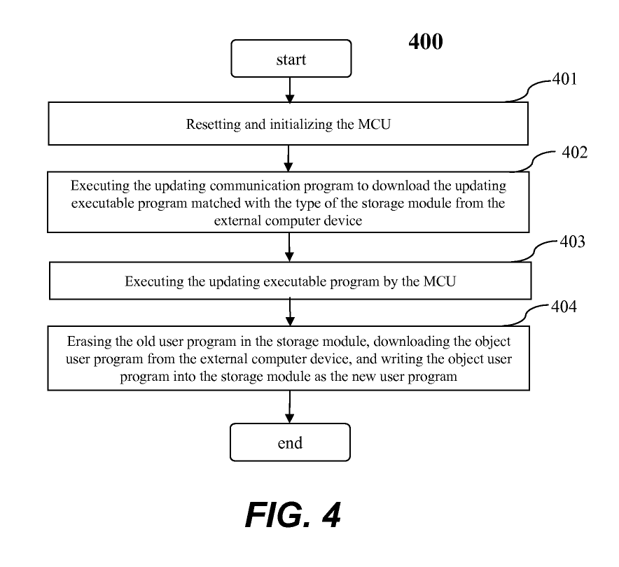

FIG. 4 is a flowchart or process 400 illustrating an exemplary updating method according to one embodiment of the present invention. At 401, the MCU is reset and initialized after being powered on. If the user program is in the storage module 206 is caused to be updated, the process 400 goes to 402.

At 402, a program counter of the MCU points to the ROM of the MCU firstly, and then the MCU executes the updating communication program in the ROM to download the updating executable program compatible with the type of the storage module 206. The downloaded updating executable program is loaded into a RAM.

The updating communication program in the ROM is provided for establishing a communication channel with the external computer device and downloading the updating executable program from the external computer device. The process of establishing the communication channel may be an enumerating process of the USB. The updating executable program mainly explains how to update the storage module (also referred to as how to reprogram the storage module). The updating executable program consists of a series of functions such as an erasing function, a programming function etc.

The electronic devices have various types of storage modules, so it is a difficult problem to update the various types of storage modules by the MCU. According to one embodiment of the present invention, the firmed updating communication program is provided only for establishing a communication link with the external computer device, and the updating executable program according to which the storage module is updated is downloaded from the external computer device. Hence, only if the updating executable program matches with the type of the storage module 206, the updating executable program is determined to be downloaded. Thus, the MCU is compatible with various types of storage modules by executing the matched updating executable program.

The process to download the updating executable program matched with the type of the storage module specifically comprises: sending a type identifier of the storage module to the external computer device by the MCU, looking up corresponding updating executable program according to the type identifier of the storage module, and downloading corresponding updating executable program into the RAM. Likewise, the user may also configure the MCU to download a predetermined updating executable program from the external computer device.

The updating method of the present invention not only enhances the updating reliability but also is compatible with various types of storage modules, thereby facilitating the use of the electronic device.

At 403, the MCU executes the updating executable program in the RAM. Namely, the MCU calls various functions contained in the updating executable program.

At 404, the MCU erases the old version of user program in the storage module by calling the erasing functions, downloads the object user program from the external computer device into the RAM, and writes the object user program from the RAM into the storage module by calling the programming function. Thus, the object user program is wrote into the storage module as a new version of user program.

As ordinary peoples skilled in the art know, the updating communication program, the updating executable program and the object user program may be implemented according to the conventional techniques. For example, the conventional updating program may be divided into the updating communication part and the updating executable part by functions, the updating communication program is obtained by adding a function of downloading the updating executable part to the updating communication part. Accordingly, the updating executable program may also be implemented.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. An updating method, comprising:
firming an updating communication program into a micro control unit (MCU);
executing the updating communication program by the MCU to download an updating executable program from an external equipment; and
executing the updating executable program by the MCU to download a user program and write the user program into a storage module.

2. The method according to claim 1, wherein the updating communication program is firmed into a ROM of the MCU.

3. The method according to claim 1, wherein the executing of the updating communication program by the MCU to download the updating executable program from the external equipment comprises:
establishing a communication channel with the external equipment by USB enumeration; and
downloading the updating executable program matched with a type of the storage module from the external equipment.

4. The method according to claim 3, wherein the downloading of the updating executable program matched with the type of the storage module from the external equipment comprises:
sending a type identifier of the storage module to the external equipment;
looking up corresponding updating executable program according to the type identifier of the storage module; and
downloading corresponding updating executable program.

5. The method according to claim 1, wherein the executing of the updating executable program by the MCU to download the object user program and write the object user program into the storage module comprises:
erasing an old version of user program in the storage module;
downloading the object user program from the external equipment; and
writing the object user program into the storage module as a new version of user program.

6. The method according to claim 1, wherein the updating of the executable program comprises a series of functions including an erasing function and a programming function.

7. The method according to claim 1, wherein the storage module is a nonvolatile memory.

8. An updating system, comprising:
an external equipment for storing an updating executable program and an object user program;
a storage module for storing an user program required to be updated; and
a micro control unit (MCU) comprising an updating communication program firmed therein, the MCU executing the updating communication program to download the updating executable program from the external equipment, executing the updating executable program to download the object user program from the external equipment, erase an old version of user program in the storage module, and write the object user program into the storage module as a new version of user program.

9. The system according to claim 8, wherein the updating communication program is firmed in a ROM of the MCU.

10. The system according to claim 8, wherein the storage module is a nonvolatile memory.

11. The system according to claim 8, wherein the MCU comprises a storage unit for firming the updating communication program therein, an obtaining unit for downloading the updating executable program matched with a type of the storage module from the external equipment by executing the updating communication program, and an executing unit for executing the updating executable program to download the object user program from the external equipment, erase the old user program in the storage module, and write the object user program into the storage module.

12. An electrical device, comprising:
a system on chip comprising a micro control unit (MCU) having a ROM for storing an updating communication program and a storage module for storing an user program; wherein, when the user program is required to be updated, the MCU executes the updating communication program to download an updating executable program matched with a type of the storage module from an external equipment, and then executes the updating executable program to erase an old version of user program in the storage module, download a new version of user program from the external equipment and write the new version of user program into the storage module.
